(19) United States
(12) Patent Application Publication
(10) Pub. No.: US 2008/0224371 A1
(43) Pub. Date: Sep. 18, 2008

(54) WHEEL SUSPENSION

(75) Inventors: Robert Brand, Attendorn (DE); Jorg Neubrandt, Freudenberg-Alchen (DE); Hans-Ulrich Kriese, Weissensee (DE)

Correspondence Address: CESARI AND MCKENNA, LLP, 88 BLACK FALCON AVENUE, BOSTON, MA, 02210, US

(73) Assignee: Muhr und Bender KG, Attendorn (DE)

(21) Appl. No.: 12/032,332

(22) Filed: Feb. 15, 2008

(30) Foreign Application Priority Data
Feb. 15, 2007 (DE) 10 2007 008 059.1
Aug. 12, 2007 (DE) 10 2007 038 070.6

(51) Int. Cl. F16F 13/00

(52) U.S. Cl. 267/221

(57) ABSTRACT

A wheel suspension has a wheel-guiding McPherson strut unit which includes a helical compression spring and a shock absorber, and which is connected to a vehicle body, on the one hand, and to a wheel on the other, and with a suspension arm wherein the compression spring is provided between an upper spring plate connected to the body and a lower spring plate connected to the shock absorber. The undesired, but unavoidable relative movements between the lower spring end of the compression spring and the lower spring plate connected to the shock absorber have an effect that is less negative than usual due to a coating provided between the lower spring end of the helical compression spring and the lower spring plate connected to the shock absorber protecting the lower spring end of the helical compression spring and/or the lower spring plate connected to the shock absorber.

### BACKGROUND OF THE INVENTION

The invention relates to a wheel suspension with a wheel-guiding McPherson strut unit which has a helical compression spring and a shock absorber, and which is connected to the vehicle body, on the one hand, and to the wheel on the other, and with a suspension arm wherein the helical compression spring is provided between an upper spring plate connected to the body and a lower spring plate connected to the shock absorber. The parts previously designated as upper spring plate and lower spring plate are also often designated as spring plate.

In wheel suspensions of the type basically under consideration here, also often called McPherson strut wheel suspensions, the upper suspension arm, which is pre-sent in other conventional wheel suspensions, is replaced by a long-stroke McPherson strut unit (Lueger “Lexicon der Technik”, Volume 12 “Lexikon der Fahrzeugtechnik”, 1967 Deutsche Verlags-Anstalt GmbH, p. 425).

In the present wheel suspensions transverse forces generally arise that need to be absorbed by the piston rod of the shock absorber. That gives rise to considerable frictional forces on the piston of the shock absorber and consequently leads to a jerking spring deflection or rebound.

For decades, experts have been extensively dealing with the above-mentioned problem of transverse forces in wheel suspensions of the type under consideration here. In this respect, reference is made to German Patent Application 1 506 616, the German Patent 37 43 450 and the corresponding European Patent 0 319 651, the PCT publication WO 01/56.819 and the German Patent 101 25 506, in particular, however, to the extensive embodiment of the problem and various solutions to these problems in the non-published German Patent Application 10 2006 060 149.1, which exist as German Patent Application 10 2006 060 149, when this patent is published. The disclosure content of the previously listed pre-published publications and the disclosure content of the German Patent Application 10 2006 060 149.1 are thus expressly also to be made disclosure content of this patent application, i.e. incorporated by reference herein.

The object of the teaching of German Patent Application 10 2006 060 149.1 is to improve the known wheel suspension from German Patent 37 43 450 or, alternately known from German Patent 101 25 503 in respect to reduction of weight. This present patent application deals with a different problem.

In the wheel suspensions of the type under consideration here, there is a system consisting of the helical compression spring on the one hand as well as the upper spring plate connected to the body and the lower spring plate connected to the shock absorber. This system leads, on the one hand, to desired relative movements, namely between the upper spring plate and the lower spring plate, on the other hand, to undesired, but not avoidable relative movements between the spring ends of the helical compression spring, on the one hand, and the upper spring plate or, respectively the lower spring plate, on the other hand, in particular between the lower spring end of the helical compression spring and the lower spring plate. These relative movements are unavoidable because, on the one hand, the deflection and rebound of the helical compression spring, is, by all means a complicated structure and because, however, on the other hand, particularly the system of the helical compression spring as well as of the upper spring plate and the lower spring plate is geometrically or, respectively, spatially complicated in terms of deflection and rebound.

In order to understand what is stated in the following, some specifications first need to be made:

The lengthwise direction of the vehicle shall be called the X-direction, the direction running perpendicular to the lengthwise direction of the vehicle shall be called the Y-direction; the direction perpendicular to the X-direction and perpendicular to the Y-direction shall be called the Z-direction. Consequentially, the planes running perpendicular to the lengthwise direction of the vehicle are called XZ-planes and the planes running along the direction of the vehicle are called YZ-planes.

If the pre-defined X-Y coordinated are arranged so that X=0 and Y=+ for the center of a circle, it is thus also stipulated that based on this center −X=max, for the angle 0°, X=0 and Y=max, for the angle 90°, X=max, for the angle 180° as well as X=0 and Y=min. for the angle 270°.

The helical compression spring of the wheel suspension of the type being considered here has a spring center line (see German Patent Application 10 2006 060 149.1) and a line of action of the spring force. For reasons explained in the prior art (compare German Patent Application 10505 616, German Patent 37 13 450, the PCT document WO 01/56.819 and the German Patent 101 35 503 as well as German Patent Application 10 2006 060 149.1) the spring center line and the line of action of the spring force do not coincide. The results can be or, respectively the results are that the end points of the spring center line, on the one hand, and the line of action of the spring force, on the other hand come apart. This is generally not desired in the upper spring plate connected to the body, but more of a result of unavoidable tolerances; however, in the lower spring place connected to the shock absorber desirable in order to eliminate or, respectively reduce transverse forces that would otherwise occur. This coming apart of the ends of the spring center line, on the one hand, and the line of action of the spring force, on the other hand, is also called offset and shall be called offset in the following.

The size of the relative movement between the spring ends of the helical compression spring, on the one hand, and the upper spring plate connected to the body or, respectively the lower spring plate connected to the shock absorber, on the other hand, depends on the size of the above-mentioned offset. Since, as described, the upper offset is relatively small, but the lower offset is relatively large, disadvantages arise with the undesired, but unavoidable relative movement; particularly on the lower spring end of the helical compression spring or, respectively, on the lower spring plate connected to the shock absorber. In the following, only the lower spring end of the helical compression spring and the lower spring plate connected to the shock absorber will be considered from the system in consideration here, even if what is described in the following applies, even in the least amount, to the upper spring end of the helical compression spring and the upper spring plate connected to the body.

The helical compression springs consisting of spring steel used in the wheel suspensions under consideration here are generally completely coated, e.g. provided with a protective lacquer to protect the metal surface, in particularly against mechanical damage, e.g. stone chops, and again chemical damage, namely corrosion, which could occur over time, in particular from moisture, e.g. from saltwater. Nevertheless, damages occur to the coating of the helical compression spring where the described undesired, but unavoidable relative movement between the lower spring end of the helical compression spring and the lower spring plate connected to the shock absorber, for example chafing particles entering into this area and through occurring corrosion, in particular through corrosion that is, in turn, the result of chafing particles. In the end, spring fractures occur again and again in the area of the lower spring end of the helical compression spring, so that the helical compression springs have to be oversized in order to avoid such spring fractures or, respectively, the material used cannot be optimally taken advantage of.

### SUMMARY OF THE INVENTION

Thus, the object of the invention is to improve the known wheel suspension in such a manner that the undesired, but unavoidable relative movement between the lower spring end of the helical compression spring and the lower spring plate connected to the shock absorber have a less negative effect than the prior art and/or that less relative movement occurs that in the prior art.

The wheel suspension according to the invention, in which the derived and described object is met, is characterized essentially in that a coating is provided between the lower spring end of the helical compression spring and the lower spring plate connected to the shock absorber at least partially protecting the lower spring end of the helical compression spring and/or the lower spring plate connected to the shock absorber, i.e. an additional coating to the coating already provided on the helical compression spring.

The provided special or, respectively additional coating according to the invention can be achieved on the lower spring end of the helical compression spring, on the lower spring plate connected to the shock absorber or both on the lower spring end of the helical compression spring and on the lower spring plate connected to the shock absorber; however, the coating is preferably achieved only on the lower spring plate connected to the shock absorber.

How the coating under consideration here in applied in detail, i.e. how the corresponding area is coated is left up to the person skilled in the art. He will apply his technical knowledge and competence, which, e.g. is documented in “Wikipedia, the Free Encyclopedia: under the header or keyword “coating”. This technical knowledge and competence documented as described above is thus expressly included in the disclosure content of this patent application.

In the wheel suspension according to the invention, the coating under consideration here consists preferably of rubber or of plastic. If the coating consists of rubber, the invention can be realized so that the coating is vulcanized onto the lower spring end of the helical compression spring in the area coming in contact with the lower spring plate connected to the shock absorber. If, on the other hand, an coating of plastic is realized, different methods can be used depending on the type of plastic to be applied; in particular, the materical can be applied using chemical vapor deposition (CVD), physical vapor deposition (PVD) or plasma spraying. Furthermore, a person skilled in the art can also use his knowledge and competence as it is documented in “Wikipedia, the Free Encyclopedia” under the header of keyword “coating” as well as under the headers or keywords “chemical vapor deposition”, “physical vapor deposition”, and “plasma spraying”.

As described above, the object of the invention is to improve the wheel suspension in such a manner that the undesired, but unavoidable relative movement between the lower spring end of the helical compression spring and the lower spring plate connected to the shock absorber have a less negative effect than the prior art and/or that there is less relative movement in the type under consideration. The first part of this object is met with what has previously been described, in other words that a particular undesired, but unavoidable relative movement between the lower spring end of the helical compression spring and the lower spring plate connected to the shock absorber is accepted and the damaging effects of exactly this relative movement are reduced or, respectively even entirely eliminated.

The object forming the basis of the invention, precisely, the second part of this object can, however, also be dissociated from what has been described, but can additionally be met in that the undesired, but unavoidable relative movement between the lower spring end of the helical compression spring and the lower spring plate connected to the shock absorber is reduced in size, which can be realized using different methods either individually or cumulatively.

It was mentioned above that, for the known wheel suspension upon which the invention is based, the line of action of the spring force does not coincide with the spring center line which leads to a falling apart of the end points of the spring center line on the one hand and the line of action of the spring force on the other hand, which is desired in the lower spring plate connected to the shock absorber in order to eliminate or, respectively, to reduce occurring transverse forces. This falling apart of the ends of the spring center line, on the one hand, and the line of action of the spring force, on the other hand, is called offset and shall be called spring plate offset in the following.

According to a further teaching of the invention, which is important also on its own, but in particular in connection with what has already been described, the desired spring plate offset for compensating transverse forces in the area of the lower spring plate connected to the shock absorber is realized partially by the geometry of the spring plate and partially by the geometry of the helical compression spring. In detail, the spring plate offset can be realized to about 35% to 50%, in particular to about 40% to 45% by the geometry of the spring plate and to about 50% to 65%, in particular to about 55% to 60% by the geometry of the helical compression spring.

According to a further teaching of the invention, which again is important also on its own, but in particular in connection with what has already been described, a further teaching of the invention characterized in that the lower spring plate connected to the shock absorber is not arranged exactly perpendicular to the piston rod of the shock absorber, i.e. a spring plate slope is realized, i.e. the plane of the lower spring plate connected to the shock absorber runs at an acute angle to the piston rod of the shock absorber, preferably at an angle of about 84° to 88°, in particular at an angle of about 86°.

Different specifications were made above, including ones for an X-Y coordinate system. Under consideration of these specifications there is another teaching of the invention, which is of importance on its own, i.e. dissociated from the measures described thus far, which aligns the helical compression spring at an angle to the lower spring plate connected to the shock absorber, which is equal to or greater than 90°, but less than 180°. In the prior art, the helical compression spring is at an angle to the lower spring plate connected to the shock absorber greater than 270°, less than 360° (compare DE 42 03 658 C2) or, respectively, equal to 180° (compare DE 102 58 936 A1). In contrast, it has been discovered according to the invention that the undesired relative movement between the lower spring end of the helical compression spring and the lower spring plate connected to the shock absorber can be strongly reduced if the helical compression spring is aligned at an angle to the lower spring plate connected to the shock absorber that is equal to or greater than 90°, but less than 180°.

In particular, there are a host of possibilities for embodying and developing the wheel suspension in accordance with the invention. A preferred embodiment of the wheel suspension in accordance with the invention is described below in conjunction with the accompanying drawings.

### BRIEF DESCRIPTION OF THE DRAWINGS

In the drawings:

FIG. 1 is a representation for use in explaining the forces which occur in a wheel suspension of the type under consideration;

FIG. 2 is a representation of a wheel suspension, in which transverse forces no long occur;

FIG. 3 is a top view of the preferred embodiment of a lower spring plate connected to the shock absorber of a wheel suspension according to the invention;

FIG. 4 is a perspective representation showing the lower spring end of a helical compression spring and a lower spring plate, not built into a wheel suspension, moreover built for measuring and experimental purposes;

FIG. 5 is a diagram for explaining spring plate offset and spring plate slope, and

FIGS. 6a to 6c are representations for suppression of the relative movement between the lower spring end of the helical compression spring and the lower spring plate connected to the shock absorber.

### DESCRIPTION OF A PREFERRED EMBODIMENT

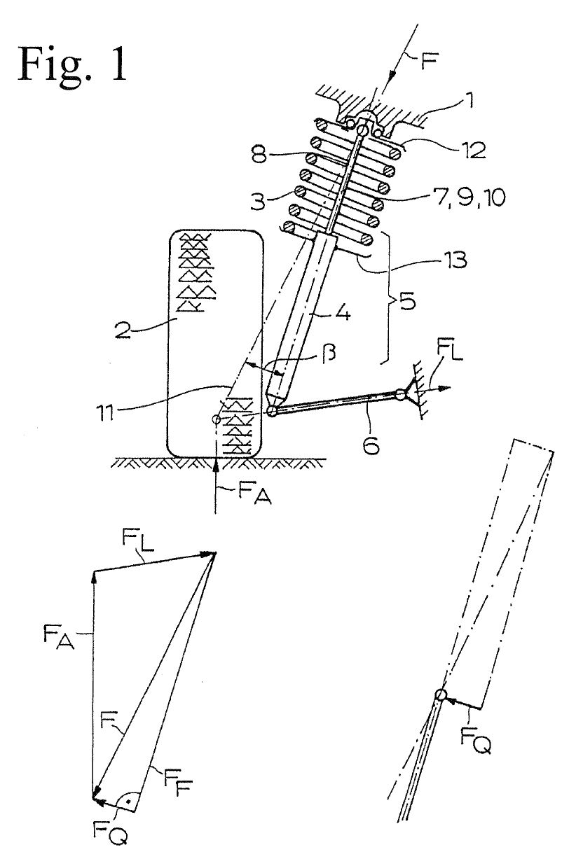

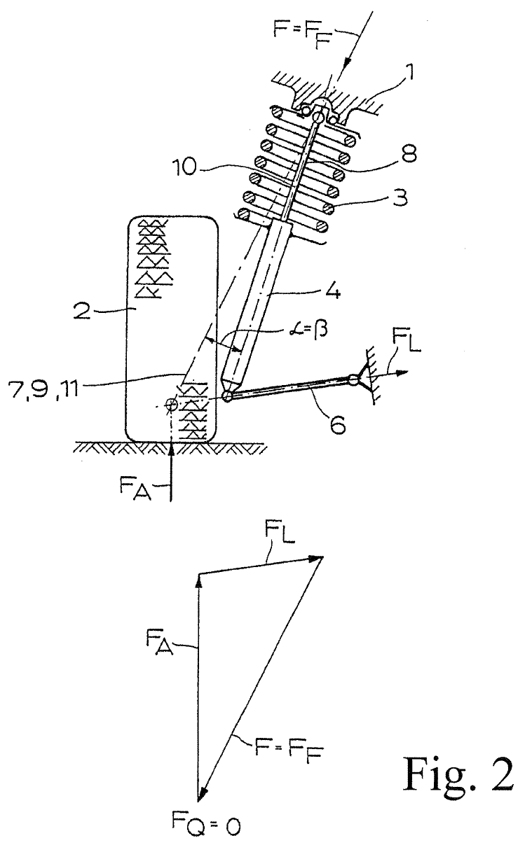

A wheel-guiding McPherson strut unit 5 having a helical compression spring 3 (=suspension spring or, respectively, axle spring) and a shock absorber 4, and being connected to the body 1 and to the wheel 2 as well as a suspension arm 6 belong to the wheel suspension represented in FIGS. 1 and 2. The spring center line 7 of the helical compression spring 3 is also depicted. That spring center lines are not physically existent and how spring center lines are determined in helical compression springs is referred to in the corresponding embodiment in the not yet published German Patent Application 10 2006 060 149.1.

As can be taken from FIG. 1, a force equilibrium is established between the different forces, specifically between the wheel contact force F_{A}, the arm force F_{L}, the body support force F, the spring force F_{F} and the transverse force F_{Q}. The unwanted transverse force F_{Q}, which leads to friction forces on the piston of the shock absorber 4 and which is to be accommodated by the piston rod 8 of the shock absorber 4, results from the angle α between the line of action of the spring force 9 of the helical compression spring 4 and the shock absorber axis 10, on the one hand, and the angle β between the line of support action 11 and the shock absorber axis 10, on the other hand, not being the same, i.e. the line of action of the spring force 9 and the line of support action 11 do not coincide.

In the wheel suspension shown in FIG. 2, the angle α between the line of action of the spring force 9 of the helical compression spring 3 and the shock absorber axis 10, on the one hand, and the angle β between the line of support action 11 and the hock absorber axis 10, on the other hand, are the same; therefore, the line of action of the spring force 9 and the line of support action 11 coincide. This situation results in the helical compression spring force F_{F} and the body support force F being the same, and the transverse force F_{Q} is therefore zero.

The helical compression spring 3 in the known wheel suspensions is preferably arranged so that the transverse forces can be partially compensated by the helical compression spring 3; these forces would be exerted on the shock absorber 4 without the compensating effect of the helical compression spring 3. The helical compression spring 3 is also preferably arranged in the described manner in a wheel suspension according to the invention. In the wheel suspension according to the invention, the measures described in German Patent 101 25 503 for compensating the destabilizing steering moment can be realized, but need not be realized. In the wheel suspension according to the invention measures can also be realized that are described in the not yet published German Patent Application 10 2006 060 149.1. The same applies here, that these measures can be realized, but need not be realized.

In addition, it should be added that in the wheel suspension shown in FIGS. 1 and 2, the helical compression spring 3 is provided between an upper spring plate 12 connected to the body 1 and a lower spring plate 13 connected to the shock absorber 4.

Above, it is explained in detail that in the wheel suspension of the type being considered here, of the prior art, an undesired, but unavoidable relative movement occurs between the spring ends of the helical compression spring 3, on the one hand, and the upper spring plate 12 or, respectively, the lower spring plate 13, on the other hand, in particular to relative movement between the lower spring end of the helical compression spring 3 and the lower spring plate 13. It is also explained above what negative effects these relative movements have and that it is the object of the invention to improve the known wheel suspension in such a manner that the undesired, but unavoidable relative movements between the lower spring end of the helical compression spring 3 and the lower spring plate 13 connected to the shock absorber 4 have a less negative effect than the prior art.

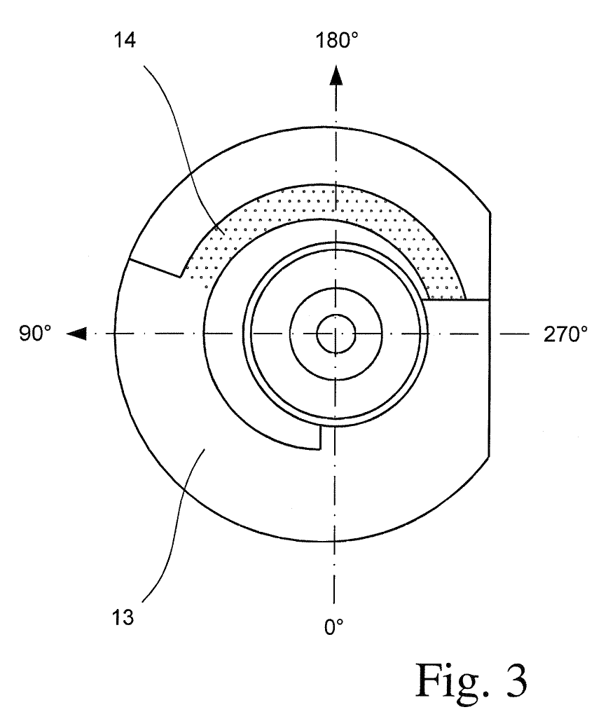

According to the invention and as first indicated in FIG. 3, a coating 14 is provided between the lower spring end of the helical compression spring 3 and the lower spring plate 13 connected to the shock absorber 4 protecting at least partially one of the lower spring end of the helical compression spring 3 and/or the lower spring plate 13 connected to the shock absorber 4. Preferably, this coating 14 is realized, as shown in FIG. 3, only on the lower spring plate 13 connected to the shock absorber.

Preferably, the coating 14 consists of rubber or of plastic. If the coating 14 consists of rubber, the invention can be realized so that the coating 14 is vulcanized onto the lower spring end of the helical compression spring 3 in the area coming in contact with the lower spring plate 13 connected to the shock absorber 4. If a coating 14 of plastic is realized, the coating 14 can be applied on the lower spring end of the helical compression spring 3 in the area coming in contact with the lower spring plate 13 connected to the shock absorber 4 using chemical vapor deposition (CVD), physical vapor deposition (PVD) or plasma spraying.

There is also a possibility of choosing a coating 14 of zinc or to realize a coating 14 that contains zinc. In doing do, the coating 14 of zinc or the coating 14 containing zinc acts as a reactive anode, as is widely known from the prior art to prevent corrosion.

The object forming the basis of the invention, to improve the known wheel suspension in such a manner that the undesired, but unavoidable relative movement between the lower spring end of the helical compression spring 3 and the lower spring plate 13 connected to the shock absorber 4 has a less negative effect than the prior art, is met according to the invention in other words, that a particular undesired, but unavoidable relative movement between the lower spring end of the helical compression spring 3 and the lower spring plate 13 connected to the shock absorber 4 is accepted and the damaging effects of exactly this relative movement is reduced or, respectively, even completely eliminated, namely by the coating 14 provided by the invention.

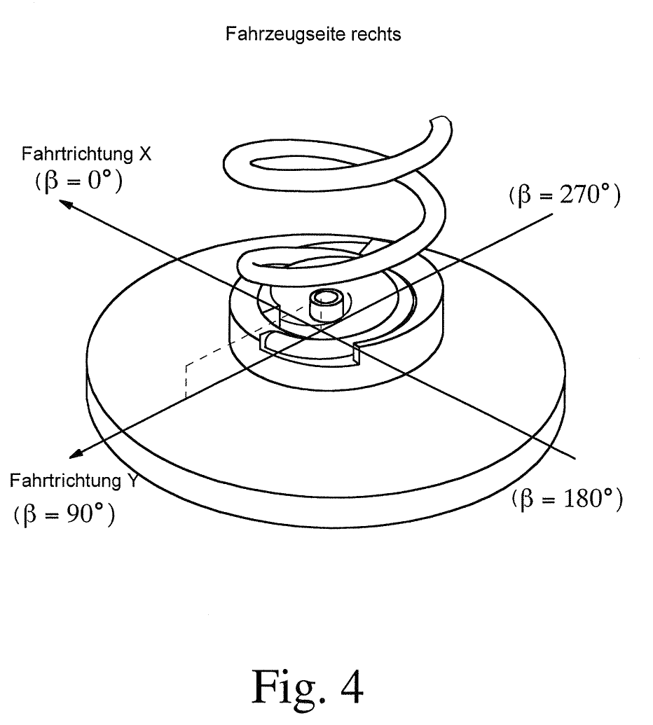

As mentioned above, a particularly advantageous teaching of the invention is characterized in that the helical compression spring 3 is aligned at a particularly chosen angle to the lower spring plate 13 connected to the shock absorber 4. FIG. 4 shows this in a perspective representation, wherein, in the embodiment shown in this representation, the angle is 90°; as a result, the plane of the contact area is 90°.

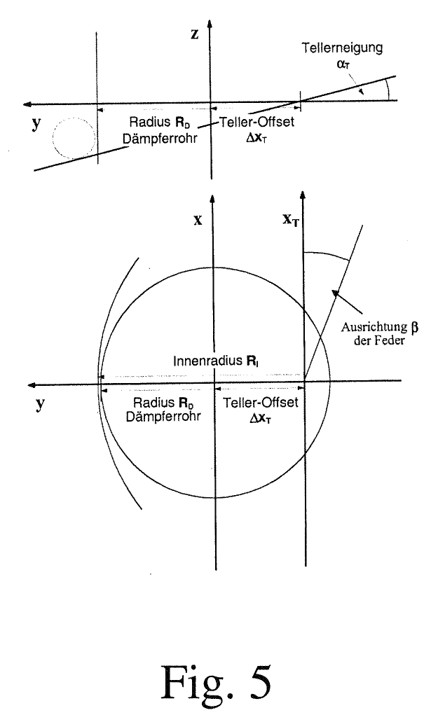

Further above, it is also described that it is part of the teaching of the invention in the area of lower spring plate 13 connected to the shock absorber 4, the spring plate offset desired for compensation of transverse forces is partially realized by the geometry of the spring plate 13 and partially be the geometry of the helical compression spring. This is shown in FIG. 5 wherein the upper part of FIG. 5 shows the relations in the YZ-plane, and the lower part of FIG. 5, the relations in the XY-plane.

The upper part of FIG. 5 also shows, in a diagam, that the lower spring plate 13 connected to the shock absorber 4 is not arranged exactly perpendicular to the piston rod 8 of the shock absorber 4. Moreover, the plane of the lower spring plate 13 connected to the shock absorber 4 runs at an acute angle to the piston rod 8 of the shock absorber 4; i.e. a slope is preferably realized in the spring plate.

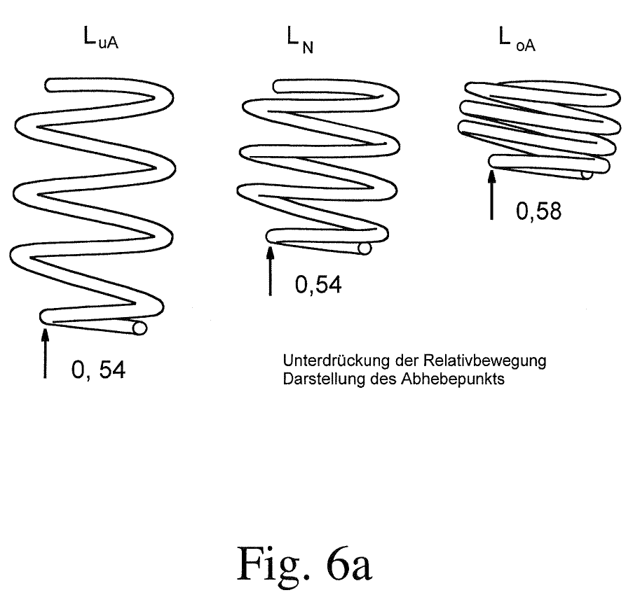

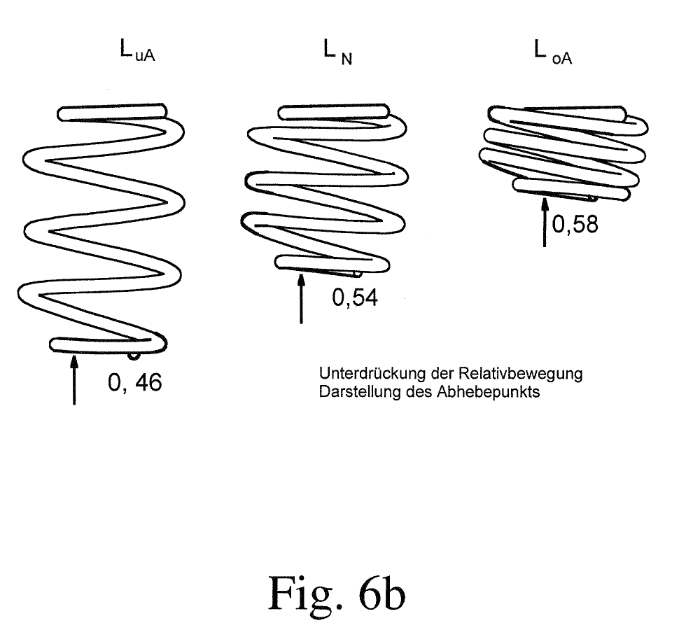

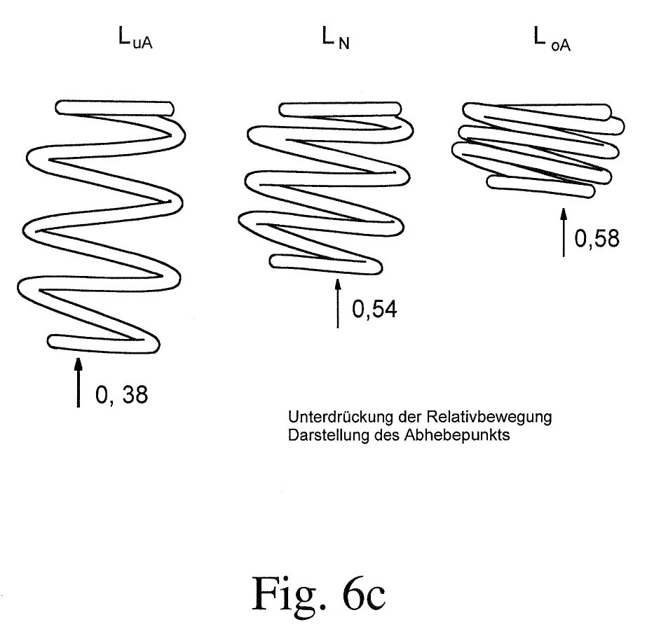

Finally, in FIGS. 6a to 6c, each achieved suppression of the relative movement between the lower spring end of the helical compression spring 3 and the lower, (not shown) spring plate is made clear and each achieved take-off point is shown. There, the relationship is shown in FIG. 6a for an angle of 90°, in FIG. 6b for an angle of 135° and in FIG. 6c for an angle of 180°. On the left of FIGS. 6a, 6b and 6c a deflected state is shown, in the middle, a state under normal load and on the right a state of maximum rebound.

1. A wheel suspension with a wheel-guiding McPherson strut unit which has a helical compression spring (=suspension spring) and a shock absorber and which is connected to a body, on the one hand, and to a wheel on the other, and with a suspension arm wherein the helical compression spring is provided between an upper spring plate connected to the body and a lower spring plate connected to the shock absorber, wherein a coating is provided between the lower spring end of the helical compression spring and the lower spring plate connected to the shock absorber protecting at least one of the lower spring end of the helical compression spring and the lower spring plate connected to the shock absorber.

2. The wheel suspension according to claim 1, wherein the coating consists of rubber or plastic.

3. The wheel suspension according to claim 2, wherein the coating consist of rubber, and wherein the coating is vulcanized into the area of the lower spring place connected to the shock absorber coming in contact with the lower spring end of the helical compression spring.

4. The wheel suspension according to claim 2, wherein the coating consists of a plastic material, and wherein the coating is applied into the area of the lower spring plate connected to the shock absorber coming in contact with the lower spring end of the helical compression spring by chemical vapor deposition (CVD), by physical vapor deposition (PVD) or by plasma spraying.

5. The wheel suspension according to claim 1, wherein the coating consists of zinc or contains zinc.

6. A wheel suspension with a wheel-guiding McPherson strut unit which has a helical compression spring (=suspension spring) and a shock absorber and which connects to a body, on the one hand, and to a wheel on the other, and with a suspension arm wherein the helical compression spring is provided between an upper spring plate connected to the body and a lower spring plate connected to the shock absorber, wherein the area of the lower spring plate connected to the shock absorber, the spring plate offset desired for compensation of transverse forces is realized partially by the geometry of the spring plate and partially by the geometry of the helical compression spring.

7. The wheel suspension according to claim 6, wherein the spring plate offset is realized to about 35% to 50% by the geometry of the spring plate and to about 50% to 65% by the geometry of the helical compression spring.

8. A wheel suspension with a wheel-guiding McPherson strut unit which has a helical compression spring (=suspension spring) and a shock absorber, and which is connected to a body, on the one hand, and a wheel on the other, and with a suspension arm wherein the helical compression spring is provided between an upper spring plate connected to the body and a lower spring plate connected to the shock absorber, wherein the lower spring plate connected to the shock absorber is not arranged exactly perpendicular to the piston rod of the shock absorber, and the plane of the lower spring plate connected to the shock absorber runs at an acute angle to the piston rod of the shock absorber, preferably at an angle of about 84° to 88°.

9. The wheel suspension according to any one of claims 1, 6 or 8, wherein the helical compression spring is aligned with the lower spring plate connected to the shock absorber at an angle that is equal to or greater than 90°, but less than 180°.
